(19) United States
(12) Patent Application Publication
(10) Pub. No.: US 2019/0176936 A1
(43) Pub. Date: Jun. 13, 2019

(54) METHOD AND SYSTEM FOR TOWING WIDELY SEPARATED SOURCES

(71) Applicant: CGG SERVICES SAS, Massy Cedex (FR)

(72) Inventor: François LE GOFF, Nantes (FR)

(21) Appl. No.: 15/839,962

(22) Filed: Dec. 13, 2017

(51) Int. Cl. B63B 21/66; G01V 1/38

(52) U.S. Cl. CPC B63B 21/66; G01V 1/3826

(57) ABSTRACT

A source front-end gear for towing marine seismic sources includes first and second umbilicals for connecting first and second seismic sources to a towing vessel; first and second deflectors; first and second connecting ropes that connect the first and second deflectors to the vessel; and first and second spur lines that connect the first and second deflectors to the first and second seismic sources. The source front-end gear is free of any mechanical connection to a front-end rigging that connects streamers to the vessel.

### BACKGROUND

### Technical Field

Embodiments of the subject matter disclosed herein generally relate to methods and systems and, more particularly, to mechanisms and techniques for towing widely separated seismic sources in water.

### Discussion of the Background

Marine seismic data acquisition and processing generate a profile (image) of the geophysical structure (subsurface) under the seafloor. While this profile does not provide an accurate location for the oil and gas, it suggests, to those trained in the field, the presence or absence of oil and/or gas. Thus, providing a high-resolution image of the subsurface is an ongoing process for the exploration of natural resources, including, among others, oil and/or gas.

FIG. 1 illustrates a marine seismic data acquisition system 100. In this side view, a vessel 110 tows seismic sources 112a and 112b and a streamer spread 114 having plural streamers (only one streamer 115 is shown in the figure) at predetermined depths under the water surface 111. Although only one streamer 115 is visible in this vertical view, plural streamers are typically spread in a three-dimensional volume. Streamer 115, which has a tail buoy 118 and likely other positioning devices attached, houses seismic receivers/sensors 116. The streamer spread 114 is connected to the vessel through a front-end rigging 117 while sources 112a and 112b are connected to the vessel through umbilicals 119.

The seismic sources generate seismic waves such as 120a and 120b that propagate through the water layer 30 toward the seafloor 32. At interfaces (e.g., 32 and 36) between layers (e.g., water layer 30, first layer 34, and second layer 38) inside which the seismic waves propagate with different wave propagation velocities, the waves' propagation directions change as the waves are reflected and/or transmitted/refracted/diffracted. Seismic waves 120a and 120b are partially reflected as 122a and 122b and partially transmitted as 124a and 124b at seafloor 32. Transmitted waves 124a and 124b travel through first layer 34, are then reflected as waves 126a and 126b, and transmitted as 128a and 128b at interface 36. At the surface of reservoir 40, waves 128a and 128b are then partially transmitted as waves 130a and 130b and partially reflected as waves 132a and 132b. The waves traveling upward may be detected by receivers 116. Maxima and minima in the amplitude versus time data recorded by receivers carry information about the interfaces and traveling time through layers.

The marine seismic data acquisition system 100 does not illustrate the connections present between the front-end rigging 117 and the umbilicals 119. In this regard, FIG. 2 shows the front-end rigging 117 including wide tow lines 220 and plural lead-ins 222. The two wide tow lines 220 connect to deflectors 224 and spread ropes 226 while the lead-ins connect to streamers 115 and spread ropes 226. FIG. 2 also shows the umbilicals 119 that connect the vessel 110 to the sources 112a and 112b. Each source 112a and 112b may include plural source elements, e.g., 112b-i, where “i” is between 2 and 20. The umbilicals 119 are connected to lead-ins 222 through various links 230 and 230′ as illustrated in FIG. 2.

Deflectors 224 are provided on the sides of this arrangement to maintain a transverse distance (relative to the path of the vessel) between streamers 115. The distance between sources 112a and 112b is about 50 m. The distance between the sources is maintained with the links 230. Thus, essentially, the deflectors 224 also maintain the source separated via spread ropes 226 and links 230. Note that the terms “rope,” “cable,” “link,” and “wire” are used sometimes interchangeably in this document. Thus, these terms should not be construed in a narrow sense, but rather as those skilled in the art would expect.

Each of source 112a and 112b may have one or more subarrays, each sub-array including plural source elements 112a-i and 112b-i, respectively. FIG. 2 shows that each source 112a and 112b includes two sub-arrays.

A single sub-array 300 is shown in FIG. 3. Sub-array 300 includes one or more floats 360 from which individual source elements 316 are suspended with cables, chains or ropes 362. In one application, clusters of individual source elements are provided at location 316. Various cables and hoses connect individual source elements 316 to the vessel for providing electric power, compressed air, data transmission, etc. For example, a hose 364 provides compressed air and a cable 366 provides electric power and/or data transmission.

Source bases 318 are connected to a bell housing 380 via a connection 382. In one application, bell housing 380 and connection 382 may form an enclosure in which the various cables 364 and 366 are entering. Bell housing 380 may be made of a resistant material, for example, stainless steel. A bend restrictor device 390 may be connected to the bell housing 380 and also to vessel 110 via an umbilical 392. Bend restrictor device 390 is configured to prevent an over-bending of the front part of the source array due to the towing force applied via umbilical 392.

As the front-end rigging for the streamers and the umbilicals for the sources are mechanically connected to each other, the current separation between the sources is about 50 m, with a maximum of about 80 m. Also, the front-end rigging of the streamers and the umbilicals have been designed for such limited separation.

However, the modern seismic survey systems require today a much larger source separation, for example, between 200 and 300 m. Such wide separation between the sources is not possible with the existing rigging. Thus, there is a need for a rigging system that can handle a large source separation.

### SUMMARY

According to an embodiment, there is a source front-end gear for towing sources. The gear includes first and second umbilicals for connecting first and second seismic sources to a towing vessel; first and second deflectors; first and second connecting ropes that connect the first and second deflectors to the vessel; and first and second spur lines that connect the first and second deflectors to the first and second seismic sources. The source front-end gear is free of any mechanical connection to a front-end rigging that connects streamers to the vessel.

According to another embodiment, there is a seismic acquisition system for acquiring seismic data. The system includes first and second seismic sources; a source front-end gear that tows the first and second sources; plural streamers having seismic sensors for recording seismic waves; and a front-end rigging that tows the plural streamers. The source front-end gear is free of any mechanical connection to the front-end rigging.

According to still another embodiment, there is a method for acquiring seismic data. The method includes deploying plural streamers with a front-end rigging, deploying at least two sources with a front-end gear, towing the plural streamers while actuating the at least two sources, and recording the seismic data with the plural streamers. The source front-end gear is independent from the front-end rigging.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional marine seismic acquisition configuration;

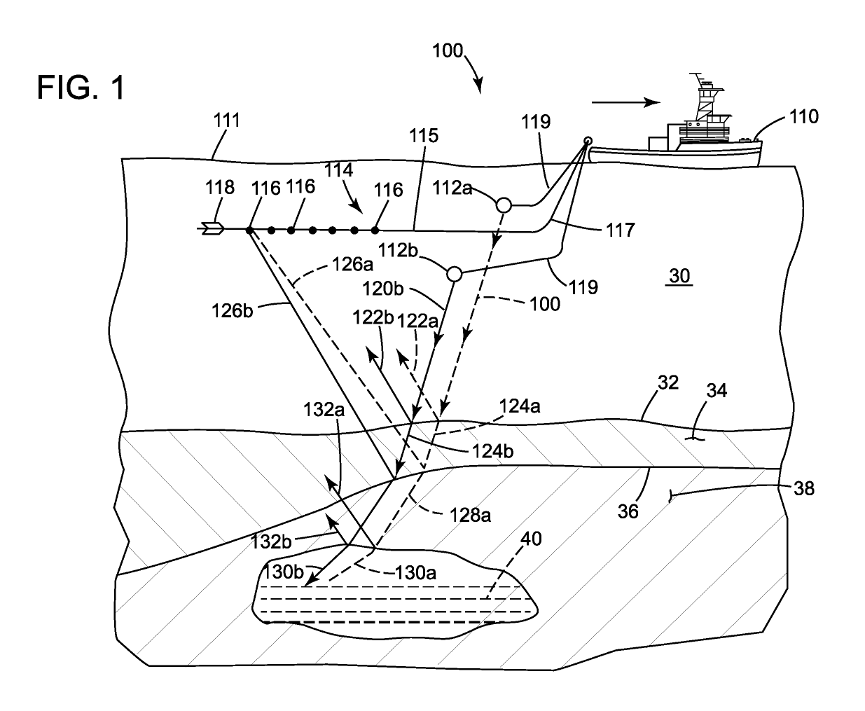

FIG. 2 is a top view of a marine seismic acquisition configuration that uses mechanical links between the sources and the lead-ins;

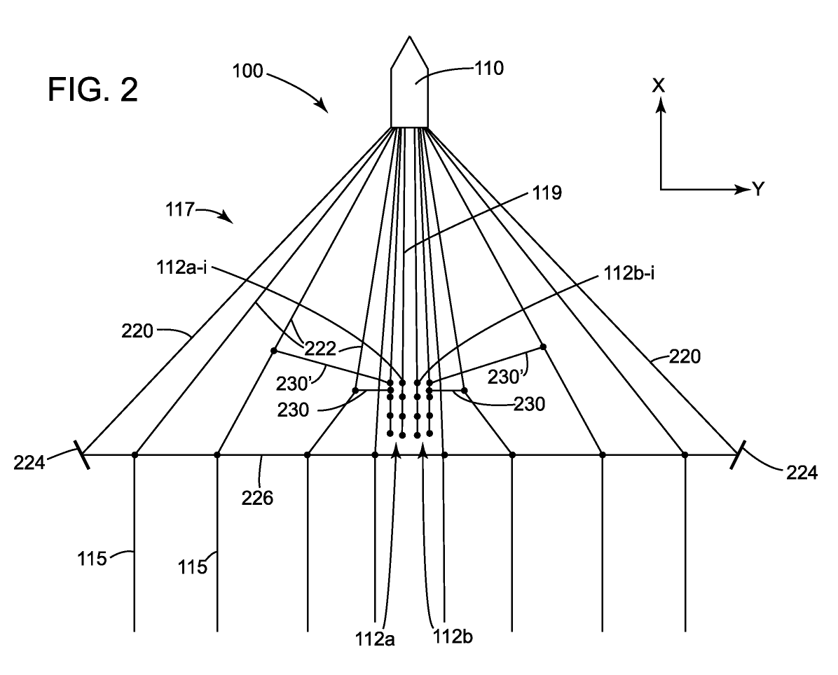

FIG. 3 is a schematic diagram of a source sub-array;

FIG. 4 is a top view of a marine seismic acquisition system that uses a dedicated source front-end gear for towing the sources;

FIG. 5 is a top view of a marine seismic acquisition system that uses a dedicated source front-end gear for towing the sources and a dedicated front-end rigging for towing the streamers and there are no mechanical links between these two mechanisms;

FIG. 6A illustrates a deflector with a float and FIG. 6B illustrates a deflector with no float;

FIG. 7 is a side view of a marine seismic acquisition system that uses a dedicated source front-end gear for towing the sources and a dedicated front-end rigging for towing the streamers;

FIG. 8 is a side view of another marine seismic acquisition system that uses a dedicated front-end gear for towing the sources and a dedicated front-end rigging for towing the streamers;

FIG. 9 is a top view of a marine seismic acquisition system that uses a dedicated source front-end gear for towing the sources and a dedicated front-end rigging for towing the streamers and the sources are located near the heads of the streamers;

FIG. 10 is a flow chart of a method for collecting seismic data with a marine seismic acquisition system that uses a dedicated source front-end gear for towing the sources and a dedicated front-end rigging for towing the streamers.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a single seismic vessel that tows streamers and three sources. However, the embodiments to be discussed next are not limited to this configuration, but may be applied to a vessel that tows more or less than three sources.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner with other features or structures in one or more embodiments.

According to an embodiment, there is a seismic data acquisition system 400 that includes a source front-end gear 410 that connects exclusively to sources 412A to 412C. This means that the source front-end gear 410 is connected between vessel 402 and the three sources (more or less sources may be used), but there is no link, wire, cable or rope mechanically connecting the source front-end gear 410 to the front-end rigging of the streamers. To reflect this independence of the source front-end gear 410 from the streamers and the front-end rigging of the streamers, the source front-end gear 410 is considered in the following to be an independent source front-end gear.

The source front-end gear 410 includes umbilicals 419A to 419C, one for each source. The umbilicals are configured to exchange compressed air (if air guns are used as the source elements), power and data between the vessel and the sources. The source front-end gear 410 also includes two source deflectors 420 and 422 connected to the outer sources 412A and 412C, respectively, with corresponding spur lines 420A and 422A. The deflectors are also connected with corresponding connecting ropes 424 and 426 to the vessel. Each deflector may have a corresponding transceiver (e.g., radio transceiver) 420B and 422B for communicating with a vessel transceiver 404. A management system 406 located on the vessel controls the communications between the vessel transceiver 404 and the deflector transceivers 420B and 422B. The radio communication between the transceivers is used, as discussed later, for adjusting a position of the deflector in water, for providing an adjustable force to the sources, so that a gap between the sources is maintained constant.

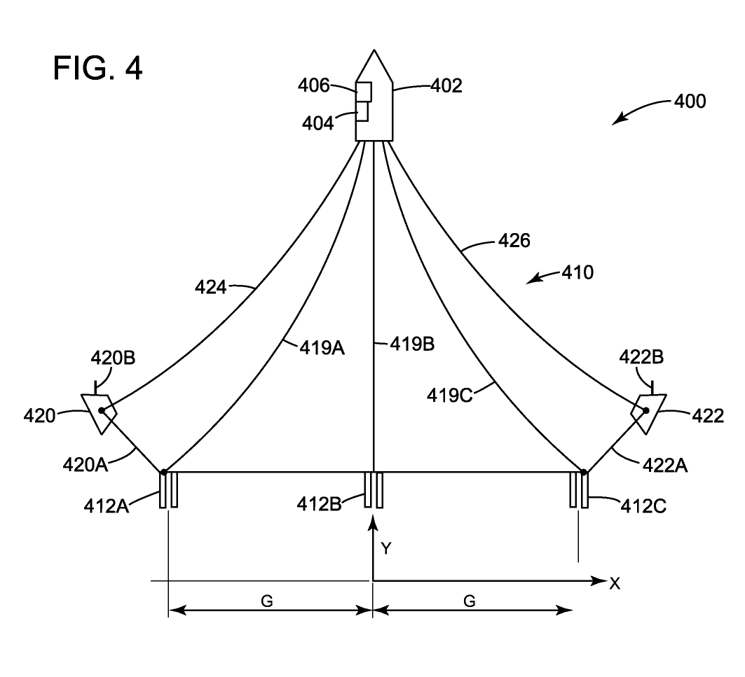

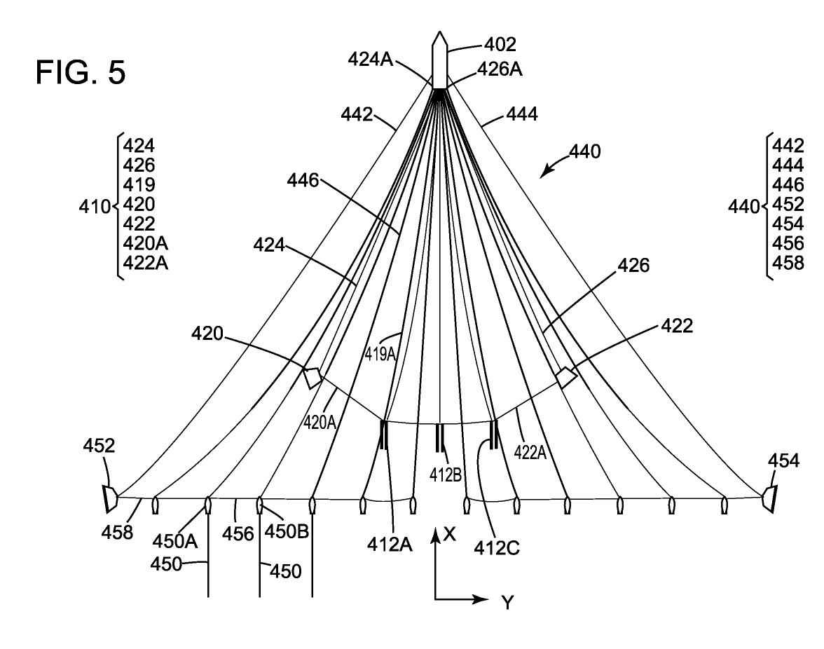

FIG. 4 shows the sources being separated by a distance G, where G can have a value between 50 and 400 m. One skilled in the art would know how to size up the deflectors for achieving even a larger gap between the sources. A deflector is an element having a surface that makes a certain angle with the direction of the vessel so that a force is generated by the movement of the deflector in water. This force is used to move the deflectors 420 and 422 away from each other, so that the separation gap G between the sources is maintained. Various shapes and sizes of a deflector are disclosed in U.S. Pat. No. 9,676,454, assigned to the assignee of this application. Note that the streamer deflectors 452 and 454 (shown in FIG. 5), which are different from the source deflectors 420 and 442, are used to maintain a separation gap between the streamers. Also, the streamer deflectors 452 and 454 maintain the separation ropes 456 between the streamers stretched.

Note that FIG. 4 shows the vessel 402 towing only the source front-end gear 410 and the sources 412A to 412C for simplicity. In fact, vessel 402 also tows the front-end rigging 440 of the streamers and the streamers 450, as shown in FIG. 5. FIG. 5 also shows the wide tow cables 442 and 444, the lead-ins 446, and associated streamer deflectors 452 and 454. The streamer deflectors are connected to the wide tow cables and spread ropes 458. The streamers 450 are separated by spread ropes 456. Each streamer 450 may have a corresponding head buoy 450A, attached to the streamer head 450B and to spread ropes 456.

One will notice that the source front-end gear 410 and the front-end rigging 440 for the streamers are now decoupled, i.e., each mechanism is independent of the other. In other words, placing the sources 412A to 412C at a desired inline position (inline axis X) and also at a desired cross-line position (cross-line axis Y is perpendicular to the inline axis X in FIG. 5), and implementing a desired gap G between adjacent sources is now possible with only the source front-end gear 410 and absolutely no involvement from the front-end rigging 440 of the streamers. The source front-end gear 410 includes at least connecting ropes 424 and 426, source deflectors 420 and 422, spur lines 420A and 422A, and umbilicals 419A to 419C while the front-end rigging 440 includes the wide tow lines 442 and 444, the plural lead-ins 446, deflectors 452 and 454, and separation ropes 456 and 458.

Connecting ropes 424 and 426 of the source front-end gear 410 may be connected to corresponding winches 424A and 426A located on vessel 402, so that a length of connecting ropes 424 and 426 may be adjusted. By adjusting the length of connecting ropes 424 and 426 and the lengths of umbilicals 419A to 419C, the inline position of the sources 412A to 412C can be adjusted.

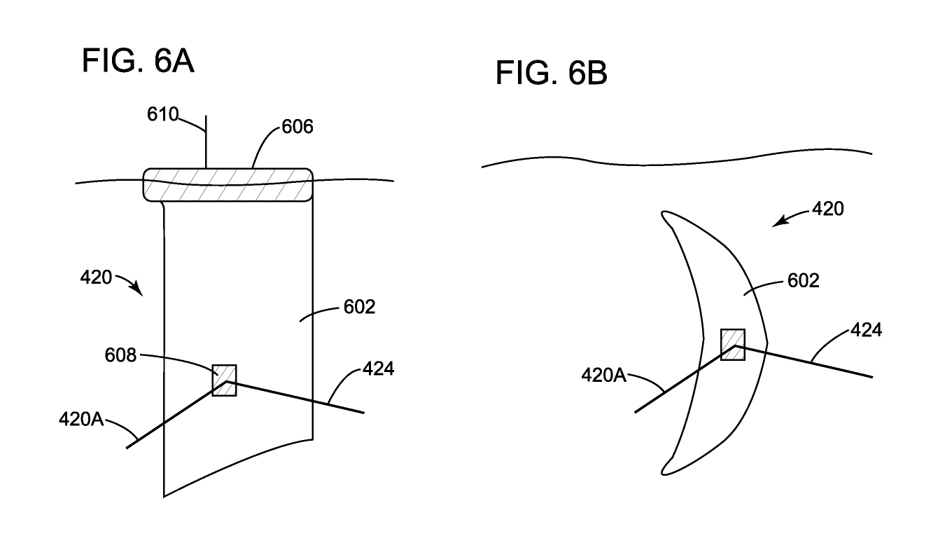

However, the addition of the source front-end gear 410 adds new elements to an already complex and extensive front-end rigging 440 and a risk exists that some ropes or other elements of the source front-end gear 410 may interfere with some ropes or other elements of the front-end rigging 440. This might become especially a serious problem given the possible configurations of the source deflectors. In this respect, FIG. 6A shows a first possible deflector 600 that has its body 602 underwater and the body is connected to a float 606. While FIG. 6A shows the body 602 directly connected to the float, it is possible that the body is connected to the float with one or more ropes. FIG. 6A also shows the connecting rope 424 and the spur line 420A connected to the deflector. In one embodiment, it is possible that the connecting rope 424 and spur line 420A connect to a control mechanism 608, which is capable of changing the attach angle of the diverter to the inline direction. Such a control mechanism 608 is known in the art and thus, not described herein. The control mechanism 608 is connected to a transceiver 610, that is located on the float 606. In this way, instructions from the vessel may be received at the transceiver 610 during the seismic survey, to adjust the attach angle of the diverter, if necessary to apply a different separating force to the sources.

FIG. 6B shows another possible implementation of the deflector 420, in which its body 602 is not connected to a float. The shape of the body 602 is selected in such a way that the forces generated by the water while the deflector moves in the water maintain the deflector at a constant depth under water, as discussed, for example, in U.S. Pat. No. 9,676,454.

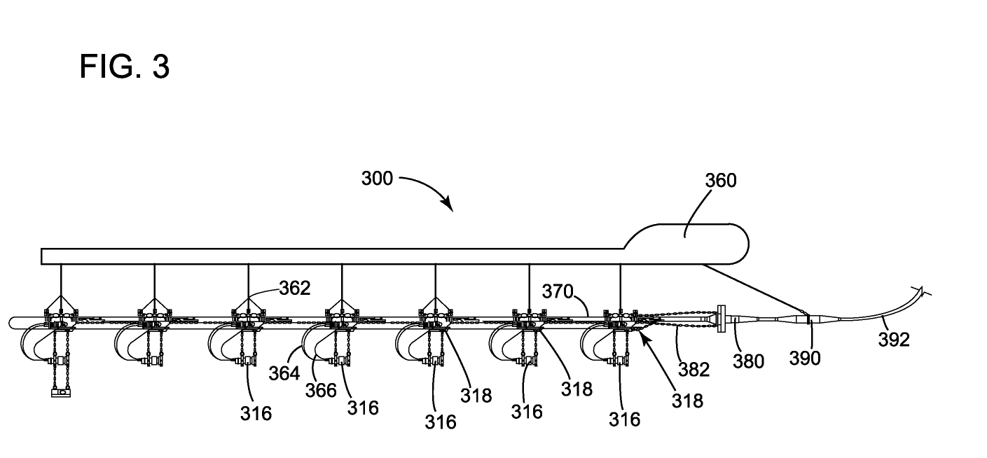

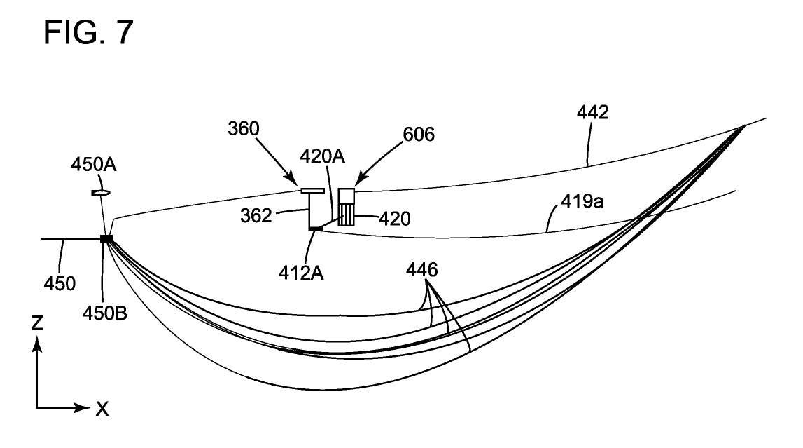

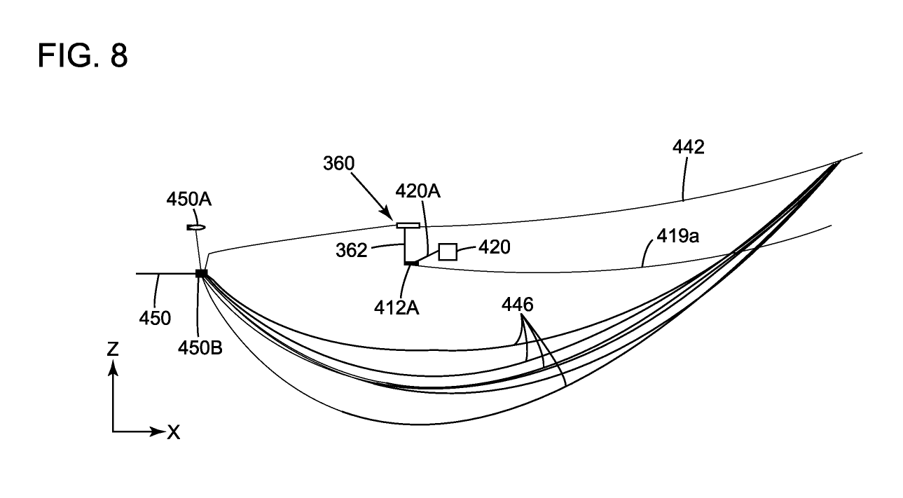

To prevent rope entanglement between the source front-end gear 410 and the front-end rigging 440, the two mechanisms are distributed/positioned in water as now discussed with regard to FIGS. 7 and 8. FIG. 7 shows an embodiment in which the source deflectors are connected to corresponding floats while FIG. 8 shows an embodiment in which the source deflectors have no floats. In both embodiments, the umbilicals 419A to 419C (only one is shown for simplicity) are located, in terms of depth (the depth is shown on the Y axis, with zero indicating the water level), below the wide tow line 442 of the streamers 450 and above the lead-ins 446. Also note that the source 412A is located below the wide tow line 442 and above the lead-ins 446, along a depth direction. FIG. 7 shows the float 606 of the source deflector 420 floating at the water surface, together with the float 360 of the source 412A. Plural links 362 connect the float 360 to the source 412A (see FIG. 3 for more details) and a spur line 420A connects the source deflector 420 to the source 412A. Note that in FIG. 8, the source deflector 420 has no float, and the source deflector 420 is connected to source 412A through a spur line 420A and the source deflector 420 is fully underwater.

With the configuration illustrated in FIGS. 7 and 8, the interaction between the elements of the source front-end gear 410 and the front-end rigging 440 is minimized, and thus, the entanglement between the ropes of the two mechanisms can be maintained to a minimum.

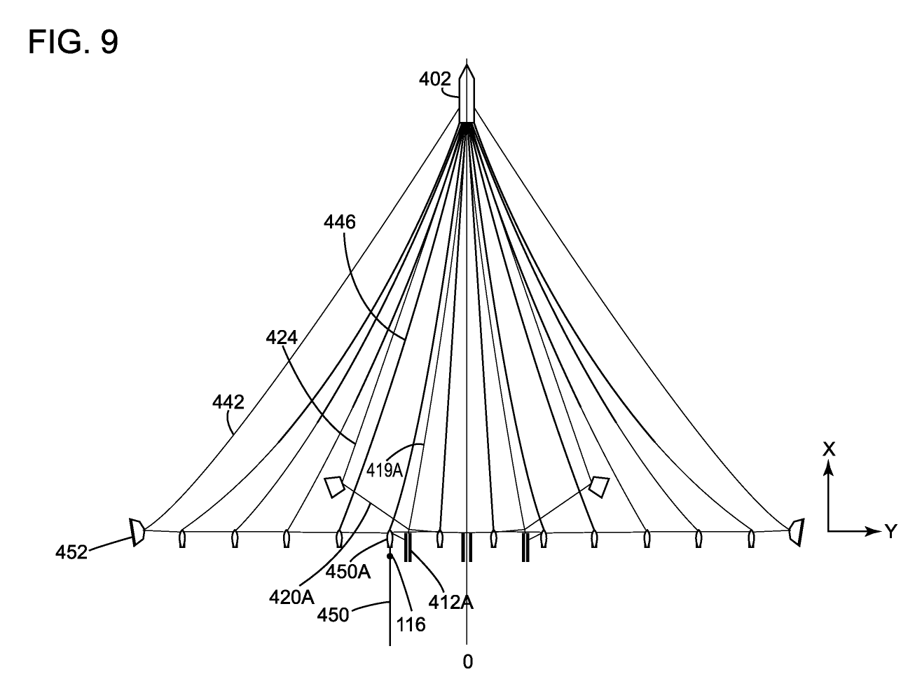

Having the source front-end gear deployed independent of the front-end rigging for the streamers, it is now possible to locate the sources close to the streamers' heads or even in line with the streamers' heads. In this regard, FIG. 9 shows the source 412A being aligned along the inline direction (X axis) with the head-buoy 450A of the streamer 450. Note that the head-buoy 450A of the streamer 450 is connected at the head portion 450B of the streamer as shown in FIGS. 7 and 8. Thus, as illustrated in FIG. 9, the source 412A (and of course the other sources) may be located to have the same inline position as the head streamer because of the independence and flexibility offered by the source front-end gear.

In this way, the source is located very close to the first receiver 116 of the streamer 450, which permits to record very low-offset seismic data, which is not possible with traditional sources because they are linked to the lead-ins 446. Being able to record very low-offset seismic data is advantageous because this data is responsible for high spatial and vertical resolution of the final image of the surveyed subsurface.

In addition, the presence of the source front-end gear allows to move the sources before operational transitions operations, as, for example, vessel turn at the end of a line, speed change, source recovery, etc. In one embodiment, it is possible to deploy the sources behind even the heads of the streamers. The source elements of the sources discussed above may be airguns, marine vibrators, or a combination of the two.

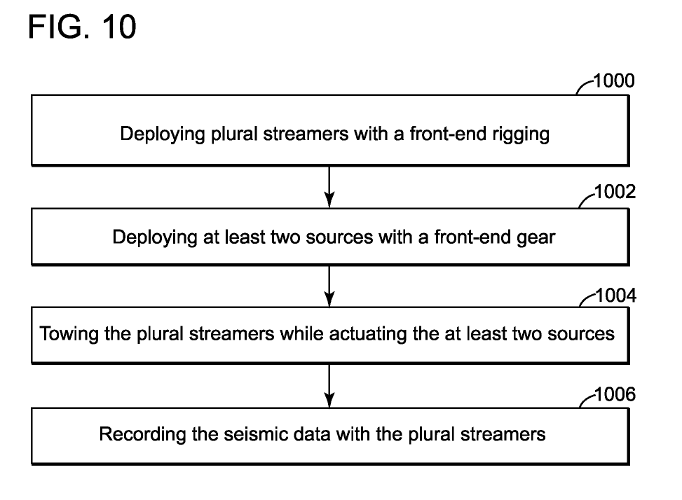

A method for acquiring seismic data with the streamer front-end rigging and the source front-end gear discussed above is now presented with regard to FIG. 10. The method includes a step 1000 of deploying plural streamers with a streamer front-end rigging, a step 1002 of deploying at least two sources with a source front-end gear, a step 1004 of towing the plural streamers while actuating the at least two sources, and a step 1006 of recording the seismic data with the plural streamers. The source front-end gear is independent from the streamer front-end rigging.

The disclosed embodiments provide a marine seismic system and a method for towing two or more sources with a desired separation gap, independent of a front-end rigging of the streamers. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A source front-end gear for towing sources, the gear comprising:
first and second umbilicals for connecting first and second seismic sources to a towing vessel;
first and second deflectors;
first and second connecting ropes that connect the first and second deflectors to the vessel; and
first and second spur lines that connect the first and second deflectors to the first and second seismic sources,
wherein the source front-end gear is free of any mechanical connection to a front-end rigging that connects streamers to the vessel.

2. The gear of claim 1, wherein the first and second umbilicals directly connect the first and second seismic sources to the vessel.

3. The gear of claim 1, wherein a gap G between the first and second seismic sources is maintained by the first and second deflectors.

4. The gear of claim 1, further comprising:
the first and second sources.

5. The gear of claim 1, wherein the first and second connecting ropes are connected to corresponding winches on the vessel, so that an inline distance between the vessel and the first and second sources is adjustable independent of the location of the streamers.

6. The gear of claim 5, wherein the inline distance between the vessel and the first and second sources is substantially the same as an inline distance between the vessel and heads of the streamers.

7. The gear of claim 1, wherein the first and second deflectors are located underwater in their entirety.

8. The gear of claim 1, wherein the first and second deflectors are attached to corresponding floats that float at the water surface.

9. The gear of claim 1, wherein the first and second spur lines are not connected to the front-end rigging.

10. A seismic acquisition system for acquiring seismic data, the system comprising:
first and second seismic sources;
a source front-end gear that tows the first and second sources;
plural streamers having seismic sensors for recording seismic waves; and
a front-end rigging that tows the plural streamers,
wherein the source front-end gear is free of any mechanical connection to the front-end rigging.

11. The system of claim 10, wherein the source front-end gear comprises:
first and second umbilicals for connecting the first and second seismic sources to a towing vessel;
first and second source deflectors;
first and second connecting ropes that connect the first and second source deflectors to the vessel; and
first and second spur lines that connect the first and second source deflectors to the first and second seismic sources, respectively.

12. The system of claim 11, wherein the front-end rigging comprises:
plural lead-ins connecting the plural streamers to the vessel;
first and second streamer deflectors;
first and second wide tow ropes connected to the first and second streamer deflectors; and
separation ropes connected between the plural streamers,
wherein the first and second streamer deflectors maintain the separation ropes stretched.

13. The system of claim 12, wherein the first and second sources are located, along a depth axis, (1) below the first and second wide tow ropes, and (2) above the plural lead-ins, along a depth direction.

14. The system of claim 12, wherein the first and second connecting ropes are connected to corresponding winches on the vessel, so that an inline distance between the vessel and the first and second sources is adjustable.

15. The system of claim 14, wherein the inline distance between the vessel and the first and second sources is substantially the same as an inline distance between the vessel and heads of the streamers.

16. The system of claim 12, wherein the first and second source deflectors are closer to the vessel than the first and second streamer deflectors, along an inline direction.

17. The system of claim 10, wherein a gap G between the first and second seismic sources is maintained by first and source second deflectors and a gap between the plural streamers is maintained by first and second streamer deflectors.

18. The system of claim 17, wherein the first and second source deflectors are different from the first and second streamer deflectors.

19. A method for acquiring seismic data, the method comprising:
deploying plural streamers with a front-end rigging;
deploying at least two sources with a front-end gear;
towing the plural streamers while actuating the at least two sources; and
recording the seismic data with the plural streamers,
wherein the source front-end gear is independent from the front-end rigging.

20. The method of claim 19, wherein the at least two sources are located, depth wise, below wide tow ropes and above lead-ins of the front-end rigging, along a depth direction.
